(19) United States
(12) Patent Application Publication
(10) Pub. No.: US 2018/0135994 A1
(43) Pub. Date: May 17, 2018

(54) Method for Optimizing the Cryogenic Pressure Tank Fill Level Which Can Be Achieved During a Refill in a Motor Vehicle

(71) Applicant: Bayerische Motoren Werke Aktiengesellschaft, Muenchen (DE)

(72) Inventors: Hans-Ulrich STAHL, Muenchen (DE); Georg MOVSISYAN, Muenchen (DE)

(21) Appl. No.: 15/869,373

(22) Filed: Jan. 12, 2018

Related U.S. Application Data
(63) Continuation of application No. PCT/EP2016/068500, filed on Aug. 3, 2016.

(30) Foreign Application Priority Data
Sep. 7, 2015 (DE) 10 2015 217 085.3

(51) Int. Cl. G01C 21/34; B60K 15/03

(52) U.S. Cl. CPC G01C 21/3469; G01C 21/3626; B60K 15/03006

(57) ABSTRACT

A method optimizes the cryogenic pressure tank fill level which can be achieved during a refill in a motor vehicle. A heating device for heating a gas in the pressure tank has at least two modes, namely a regular operating mode, in which the heating device heats the gas in the pressure tank such that a specified pressure of the gas in the pressure tank is reached, and a continuous operation mode in which the heating device constantly heats the gas in the pressure tank such that the pressure of the gas in the pressure tank rises above the specified pressure. The method has the following steps: detecting the density of the gas in the pressure tank; comparing the detected density of the gas in the pressure tank with a specified density value; and if during the comparison it is determined that the detected density falls below the specified density value, either operating the heating device in the regular operating mode or switching the heating device from the regular operating mode to the continuous operation mode, in particular on the basis of a specified path to the destination of the motor vehicle and the service stations provided on the specified path to the destination for refilling the pressure tank with gas.

### CROSS REFERENCE TO RELATED APPLICATIONS

This application is a continuation of PCT International Application No. PCT/EP2016/068500, filed Aug. 3, 2016, which claims priority under 35 U.S.C. § 119 from German Patent Application No. 10 2015 217 085.3, filed Sep. 7, 2015, the entire disclosures of which are herein expressly incorporated by reference.

### BACKGROUND AND SUMMARY OF THE INVENTION

The technology disclosed herein relates to a method for optimizing the filling level, which is able to be reached during a refilling procedure, of a cryogenic pressure tank in a motor vehicle, to a filling level optimization device for optimizing the filling level which is able to be reached during a refilling procedure of a cryogenic pressure tank in a motor vehicle and to a pressure tank with such a filling level optimization device.

Cryogenic pressure vessel systems are known from the prior art. They include cryogenic pressure vessels. Such a pressure vessel has an inner vessel and an outer vessel which surrounds the latter with the formation of a superinsulated (for example evacuated) (intermediate) space. Cryogenic pressure vessels or pressure tanks are used for example for motor vehicles in which a fuel which is gaseous under ambient conditions is stored cryogenically and thus in the liquid or supercritical state of aggregation, therefore essentially with a significantly higher density than under ambient conditions. Consequently, highly effective insulation casings (for example vacuum casings) are provided. For example, EP 1 546 601 B1 discloses such a pressure vessel.

The maximum possible density of gas in the pressure vessel or pressure tank depends on the temperature and the pressure of the gas in the pressure tank. The highest density is normally reached after a certain number of refilling/refueling procedures with gas, since then the lowest temperature in the pressure tank has been reached. In order to extract the gas from the pressure tank, the gas in the pressure tank, which gas cools down as a result of gas being extracted, is, when a predefined minimum pressure is undershot, heated at intervals in order to reach or to maintain a predefined pressure.

In previously known methods concerning the switching of a heating device for heating the gas in the pressure tank from tank-heat-exchanger regular operation, in which the gas in the pressure tank is heated slightly (at intervals) in order to (re-)establish a predefined pressure, into tank-heat-exchanger continuous operation (THE continuous operation), in which the gas in the pressure tank is heated continuously in order to increase the residual range, it is a disadvantage that, as a result of activating the THE continuous operation, as soon as a predefined density of the gas in the pressure tank is undershot, the gas in the pressure tank and the pressure tank have an extremely high temperature during the next refilling procedure of the pressure tank and, as a consequence, the pressure tank is able to receive little gas or little gas can be kept available therein. This leads to the situation in which, following corresponding heating by way of the THE continuous operation, the reachable (maximum possible) filling level is reduced when maximum refilling of the tank is carried out and, as a consequence, the maximum possible range of the motor vehicle is reduced because the pressure tank and the (residual) gas situated in the pressure tank prior to the refilling procedure has a relatively high temperature due to the heating during the THE continuous operation. The reachable filling level of the pressure tank or the density of the gas in the pressure tank is low(er) when maximum refilling is carried out, due to the heating of the gas or of the tank which is carried out.

It is an object of the technology disclosed herein to reduce or eliminate the disadvantages of the previously known solutions. Further objects will emerge from the advantageous effects of the technology disclosed herein.

The object is achieved by a method for optimizing the filling level, which is able to be reached during a refilling procedure, of a cryogenic pressure tank in a motor vehicle, wherein a heating device for heating a gas in the pressure tank has at least two modes, namely a regular operation mode, in which the heating device heats the gas in the pressure tank such that a predefined pressure of the gas in the pressure tank is reached, and a continuous operation mode, in which the heating device heats the gas in the pressure tank continuously such that the pressure of the gas in the pressure tank rises beyond the predefined pressure. The method comprises the steps of: detecting the density of the gas in the pressure tank; comparing the detected density of the gas in the pressure tank with a predefined density value; and, if during the comparison it is determined that the detected density drops below the predefined density value, then, depending on at least one item of route information of the motor vehicle, in particular depending on a determined route to the destination of the motor vehicle and on the refueling stations for refilling the pressure tank with gas which are available on the determined route to the destination, either operating the heating device in the regular operation mode or switching the heating device from the regular operation mode into the continuous operation mode.

An advantage of said method is that the heating device is switched into the continuous operation mode (in addition) depending on the route information and is not only switched into the continuous operation mode depending on the density of the gas in the pressure tank. Consequently, in comparison with a conventional method, the continuous operation mode can be activated in a delayed manner or not at all, even if a predefined density is or has been undershot. Operating or leaving the heating device in the regular operation mode for a (longer) time results in the gas in the pressure tank remaining cold for longer. As a result, the reachable filling level of the pressure tank with gas, that is to say the quantity of gas which is kept available or stored in the pressure tank, is optimized or increased when or after a maximum possible refilling procedure is carried out. Consequently, the range of the motor vehicle increases after a refilling procedure is carried out. Depending on route information, a decision is made as to whether it is necessary to switch the heating device into the continuous operation mode in order thus to increase the (residual) range with the available gas in the pressure tank. Depending on the reachability of refueling stations, in particular gas refueling stations, on the way to the destination, that is to say refueling stations along the route to the destination and/or refueling stations which are able to be reached by means of a slight detour from the route to the destination, in comparison with conventional methods, the continuous operation mode is activated later or not at all (the heating device is then operated further in the regular operation mode, in this case). Consequently, the gas in the pressure tank remains cool(er) or has a lower temperature. Thus, when refilling the pressure tank (refueling), it is possible for a higher density of gas in the pressure tank or a higher filling level to be reached. As a result, after a (maximum) refilling procedure is carried out, which is determined inter alia by the maximum possible pressure in the pressure tank (before a safety valve opens), more gas is available after the refilling into the pressure tank.

According to a further embodiment, the decision as to whether the heating device is operated in the regular operation mode, or whether the heating device is switched from the regular operation mode into the continuous operation mode, is additionally dependent on a selected refueling management mode which is selectable from multiple different refueling management modes, wherein the different refueling management modes weight differently multiple goals, such as for example travel time of the motor vehicle to the destination, number of required refueling procedures for refilling the pressure tank until reaching the destination, maximum range of the motor vehicle with the gas in the pressure tank after a maximum possible refilling procedure of the pressure tank is carried out. In the optimization of the refilling procedure of the tank with gas, the different refueling modes allow the driver or user of the motor vehicle to give to his or her most important goal priority over the other goals. The goals, that is to say short travel time of the motor vehicle to the destination, low number of required refueling procedures for refilling the pressure tank until reaching the destination, and maximum range of the motor vehicle with the gas in the pressure tank after refilling of the pressure tank is carried out, cannot all be satisfied simultaneously. Depending on the selected refueling management mode, one of said goals is preferred over the others, and the heating device is correspondingly switched from the regular operation mode into the continuous operation mode at a determined point in time which depends on the preferred goal.

In a further embodiment, a refueling station for refilling the pressure tank is furthermore selected, depending on the current gas consumption, the detected density of the gas in the pressure tank, the route information of the motor vehicle and/or the selected refueling management mode, from the refueling stations which are able to be reached with the available gas in the pressure tank, and the driver is informed about the selected or recommended refueling station. An advantage of this is that a recommendation for a refueling station is conveyed or communicated to the driver or user, in which the filling level of the tank with gas (if appropriate corresponding to the selected refueling management mode) is optimized or increased after a maximum refilling procedure is carried out. The driver or user can now decide whether he or she follows this recommendation or not.

The method may further comprise the following step of: displaying the route to the selected refueling station by means of a navigation system. An advantage of this is that the route or the information on the route about the selected or recommended refueling station is displayed in a technically simple manner to the driver. Consequently, the driver can quickly realize what he or she has to do in order to reach the recommended/selected refueling station and thus to achieve a high filling level of the pressure tank after the refilling of the pressure tank with gas.

In a further embodiment, the maximum possible filling level of the tank with gas and/or the maximum possible driving distance of the motor vehicle after the tank has been completely refilled with gas is determined in dependence on the temperature of the gas in the pressure tank and depending on the density of the gas in the pressure tank, and the decision as to whether the heating device is operated in the regular operation mode, or whether the heating device is switched from the regular operation mode into the continuous operation mode is additionally dependent on the result of this calculation. In the decision as to at which point in time, that is to say at which refueling station, refilling of the pressure tank with gas is carried out, the quantity of gas which can be stored in the pressure tank after a maximum refilling procedure (up to the maximum reachable density of the gas in the pressure tank) is carried out (this being dependent on the temperature of the gas in the pressure tank and on the pressure of the gas in the pressure tank prior to the refilling procedure), and the maximum distance which is able to be driven after the refueling with the gas in the pressure tank, is decisive. As a result of the calculation and the inclusion of this information in the decision as to whether the heating device is operated in the regular operation mode, or whether the heating device is switched from the regular operation mode into the continuous operation mode, the refilling of the pressure tank is optimized further or the reachable filling level of the pressure tank is increased. Thus, for example, it is important to some drivers that a determined minimum driving distance (minimum range) of the motor vehicle is possible, after the next refilling procedure, with the gas which is then available. The calculation of the stated values and consideration thereof results in the refilling or the reachable filling level and/or the range after the refilling of the pressure tank with gas being improved further.

In the method, if during the comparison it is determined that the detected density is below the predefined density value, the heating device can be operated in the regular operation mode in the case of a positive determination that, on the determined route to the destination, a refueling station is able to be reached with the available gas in the pressure tank without switching the heating device into the continuous operation mode. An advantage of this is that the continuous operation mode is (firstly) not activated and as a result the gas in the pressure tank is not (significantly) heated. Consequently, the quantity of gas which is available after the next (maximum) refilling in the pressure tank can be increased. Consequently, the maximum range increases after the next refilling procedure.

In the method, if it is detected that the selected refueling station is not being approached by the motor vehicle, it is possible for a new decision to be made as to whether the heating device is operated in the regular operation mode, or whether the heating device is switched from the regular operation mode into the continuous operation mode. This ensures that the motor vehicle does not break down due to lack of fuel even if the selected refueling station is not approached.

In the method, if it is detected that the selected refueling station is not being approached by the motor vehicle, it is possible for a refueling station for refilling the pressure tank to again be selected, depending on the current gas consumption, the detected density of the gas in the pressure tank, the route information of the motor vehicle and/or the refueling management mode, from the refueling stations which are able to be reached with the available gas in the pressure tank, and for the driver to be informed about the newly selected refueling station. An advantage of this is that a new refueling station is promptly selected when it is detected that the selected refueling station is not being approached, and this is communicated to the driver. Consequently, a quick and flexible response to the case where the selected refueling station is not approached is realized, and the filling level of the pressure tank is optimized under the given conditions.

The object is also achieved by a filling level optimization device for optimizing the filling level, which is able to be reached during a refilling procedure, of a cryogenic pressure tank in a motor vehicle, wherein a heating device for heating a gas in the pressure tank has at least two modes, namely a regular operation mode, in which the heating device heats the gas in the pressure tank such that a predefined pressure is reached, and a continuous operation mode, in which the heating device heats the gas in the pressure tank continuously such that the pressure of the gas in the pressure tank rises beyond the predefined pressure, wherein the filling level optimization device is formed such that, if a detected density of the gas in the pressure tank is below a predefined density value, the filling level optimization device switches the heating device from the regular operation mode into the continuous operation mode depending on route information of the motor vehicle.

An advantage of is that the filling level optimization device switches the heating device into the continuous operation mode depending on the route information and is not only switched into the continuous operation mode depending on the density of gas in the pressure tank. Consequently, in comparison with a conventional device, the continuous operation mode can be activated in a delayed manner or not at all, even if a predefined density is or has been undershot. Operating or leaving the heating device in the regular operation mode for a (longer) time results in the gas in the pressure tank remaining cold for longer. As a result, more gas can be stored or available in the pressure tank (a higher density of gas is reachable in the pressure tank) after the next (maximum possible) refilling procedure, the latter being limited by the maximum possible pressure in the pressure tank. Consequently, the range of the motor vehicle increases after a refilling procedure is carried out. Depending on route information, a decision is made as to whether it is necessary to switch the heating device into the continuous operation mode in order thus to increase the (residual) range with the available gas in the pressure tank. Depending on the reachability of refueling stations, in particular of gas refueling stations, on the way to the destination, that is to say refueling stations along the route to the destination and/or refueling stations which are able to be reached by means of a slight detour from the route to the destination, in comparison with conventional devices, the filling level optimization device activates the continuous operation mode later or not at all. Consequently, the gas in the pressure tank remains cooler or has a lower temperature. Thus, when refilling the pressure tank (refueling), it is possible for a higher density of gas in the pressure tank to be reached.

The object is also achieved by a pressure tank with an above-described filling level optimization device.

The route information and the information about the tank state (temperature, pressure and/or density) allow the switching from the regular operation mode into the continuous operation mode to be controlled efficiently. The method discussed here or rather the device discussed here is also suitable for so-called autonomous driving, in which device a data processing system or a computer controls and carries out the movements of the motor vehicle independently. In this case, the respective information (for example about the selected refueling station to be approached) are not provided (only) to the driver, but rather the motor vehicle approaches the selected refueling station independently. In this case, it is possible for the user of the motor vehicle to further select one of the multiple refueling management modes.

The filling level optimization device decides independently whether the heating device is switched into the continuous operation mode. The driver does not have to become active or does not have to intervene for this purpose. The filling level optimization device can at intervals make the decision each time anew as to whether the heating device is operated in the regular operation mode, or whether the heating device is switched from the regular operation mode into the continuous operation mode if during the comparison it is determined that the detected density drops below the predefined density value.

The route information can comprise the route, to the destination, determined (for example by the navigation system) and the refueling stations, in particular gas refueling stations, preferably hydrogen refueling stations, which are situated on the route to the destination. “Refueling stations which are situated on the route to the destination” is to be understood as meaning also refueling stations which are able to be reached with slight detours from the route to the destination or the route away from the destination (vicinity of the route). The maximum detour can be predefined or adjustable. The maximum detour for reaching the refueling station on the route to the destination is, for example, approximately 2 km, approximately 5 km, approximately 10 km or approximately 20 km. Alternatively or additionally, the calculated driving time for the detour to the refueling station can be taken into consideration.

It is also possible for information about the opening hours of the refueling stations on the route to the destination to be taken into consideration, since refilling at the respective refueling station is possible only during the opening hours.

The route information can alternatively or additionally comprise information about the (planned) distance to be driven (for the current journey), that is to say how far the motor vehicle drives, or is to drive, to the destination. Alternatively or additionally, the route information can comprise information about a desired minimum driving distance of the motor vehicle (that is to say how far is to be driven with the available gas in the pressure tank). Alternatively or additionally, a desired target range of the motor vehicle, which range is possible with the (residual) gas in the pressure tank at the end of the journey, can be used instead of or in addition to the at least one item of route information. Said information can be entered by a driver or user by way of an input unit. Said information can also alternatively be obtained or received from the navigation system. It is also conceivable that said information is obtained or received from existing historical data (that is to say from previous journeys, in particular at similar times of day or on similar dates).

A refueling station is a device for refilling or filling the pressure tank with gas. The gas can in particular be hydrogen or comprise hydrogen. The refueling station can in particular be a gas refueling station.

The technology disclosed herein relates to a cryogenic pressure vessel or pressure tank. The cryogenic pressure vessel or pressure tank is able to store fuel in the liquid or supercritical state of aggregation. A thermodynamic state of a substance which has a higher temperature and a higher pressure than the critical point is referred to as a supercritical state of aggregation. The critical point refers to the thermodynamic state in which the densities of gas and liquid of the substance coincide, said substance therefore being of monophasic form. While one end of the vapor pressure curve in a p-T diagram is characterized by the triple point, the critical point represents the other end. In the case of hydrogen, the critical point is at 33.18 K and 13.0 bar. A cryogenic pressure vessel is suitable in particular for storing the fuel at temperatures which are significantly below the operating temperature (the temperature region of the motor vehicle surroundings in which the motor vehicle is to be operated being meant) of the motor vehicle, for example at least 50 kelvin, preferably at least 100 kelvin or at least 150 kelvin below the operating temperature of the motor vehicle (generally approximately −40° C. to approximately +85° C.). The fuel can be for example hydrogen which is stored in the cryogenic pressure vessel at temperatures of approximately 30 K to 360 K. The pressure vessel can be used in a motor vehicle, which is operated for example with compressed (CNG) or liquefied (LNG) natural gas. The cryogenic pressure vessel can in particular comprise an inner vessel which is designed for storage pressures up to approximately 350 bar(g), preferably up to approximately 700 bar(g), and particularly preferably up to approximately 500 bar(g). Preferably, the cryogenic pressure vessel comprises a vacuum having an absolute pressure in the range from 10-9 mbar to 10-1 mbar, more preferably from 10-7 mbar to 10-3 mbar, and particularly preferably of approximately 10-5 mbar. The storage at temperatures (just) above the critical point has, in comparison with the storage at temperatures below the critical point, the advantage that the storage medium is of monophasic form. There are thus for example no interfaces between liquid and gaseous.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a pressure-time diagram.

FIG. 2 shows a temperature-time diagram.

FIG. 3 is a schematic view of a filling level optimization device with a pressure tank.

### DETAILED DESCRIPTION OF THE DRAWINGS

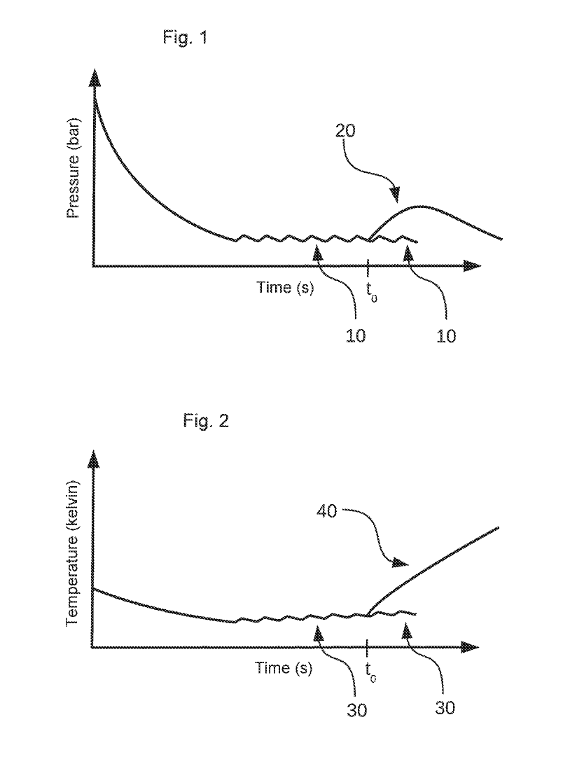

FIG. 1 shows a pressure-time diagram in which the pressure (measured in bar) is represented on the y-axis and the time (measured in seconds) is represented on the x-axis. In the region on the right in FIG. 1, the pressure profile is shown in the continuous operation mode 20, in which the pressure rises above the predefined pressure value. From point in time t0 onward, two alternatives are illustrated in FIG. 1. The upper line in the region on the right in FIG. 1 shows the pressure profile 20 if at the point in time t0 the heating device 3 is switched (due to the predefined density being undershot and in dependence on route information) from the regular operation mode into the continuous operation mode and is subsequently operated in the continuous operation mode. The lower line shows the pressure profile 10 if at the point in time t0 the heating device 3 is left in the regular operation mode or is operated in the regular operation mode. The point in time t0 is determined by the filling level optimization device 1 depending on the route information (and on the density of gas in the pressure tank). The regular operation mode is the normal, conventional operating mode if sufficient gas is available in the pressure tank 2 while gas is extracted from the pressure tank 2. In the region on the left in FIG. 1, the pressure drops continuously. In this region, no heating of the gas or the pressure tank 2 by the heating device 3 takes place. The regular operation mode of the heating device 3 is activated (region with sawtooth-like profile) only if the pressure of the gas in the pressure tank 2 drops below a predefined minimum pressure. Immediately before the point in time t0, the heating device 3 is operated in the regular operation mode.

If the heating device 3 is in the regular operation mode, the gas in the pressure tank 2 is heated by the heating device 3 at intervals in order to reach or re-establish a predefined pressure of the gas in the pressure tank 2. In the regular operation mode, the heating device 3 heats at intervals, that is to say switches on and off again. Between the heating cycles (and also during the heating cycles), gas is extracted from the pressure tank 2 and is fed to a fuel cell of the motor vehicle in order to drive the vehicle. The extraction of the gas from the pressure tank 2 results in the pressure and the temperature of the gas in the pressure tank 2 dropping. The heating device 3 must therefore repeatedly heat (slightly, that is to say by a few kelvin, for example approximately 1 K to approximately 10 K) the gas in the pressure tank 2 in order for the predefined pressure in the pressure tank 2 to again be reached or to be kept constant. The predefined pressure of the gas in the pressure tank 2 allows the gas to be extracted from the pressure tank 2 in a technically simple manner.

The cyclical heating of the gas in the pressure tank 2, when the heating device 3 is in the regular operation mode, results in the sawtooth-like form of the pressure profile 10 in the regular operation mode. The heating device 3 is or includes, in particular, a heat exchanger. It is also contemplated, however, that the heating device 3 has an electrical heater, a laser heat device and/or a wire heater. It is also possible that the heat is supplied to the pressure tank 2 or to the gas in the pressure tank 2 not at intervals but continuously. Furthermore, the heating device is also still able to (post-)heat the pressure tank 2 or the gas in the pressure tank 2 if the heating device 3 has been switched off.

In the region on the left in FIG. 2, the temperature drops continuously since gas is extracted from the pressure tank 2. In this region, no heating of the gas or the pressure tank 2 by the heating device 3 takes place. The regular operation mode of the heating device 3 is activated (region with sawtooth-like profile) only if the pressure of the gas in the pressure tank 2 drops below a predefined minimum pressure.

If the density of the gas in the pressure tank 2 drops below a predefined value, the heating device 3 is, depending on the route information, switched from the regular operation mode into the continuous operation mode (and subsequently operated in the continuous operation mode until the next refilling procedure of the pressure tank 2 with gas is carried out or the motor vehicle is powered off).

FIG. 2 shows a temperature-time diagram in which the temperature (measured in kelvin) is represented on the y-axis and the time (measured in seconds) is represented on the x-axis. The temperature profile in the regular operation mode 30 of the heating device 3 (region with sawtooth-like profile of the temperature) rises on average since a heat exchange of the gas in the pressure tank 2, or of the pressure tank 2, with the surroundings, which is not entirely avoidable, takes place. It is also possible for the sawtooth form of the temperature to have a more even profile. Moreover, in the case of continuous heat supply, no sawtooth-like profile can occur.

From point in time t0 onward, two alternatives are illustrated in FIG. 2. The upper line shows the temperature profile 40 if at the point in time t0 the heating device 3 is switched (due to the predefined density being undershot and in dependence on route information) from the regular operation mode into the continuous operation mode, and the lower line shows the temperature profile 30 if at the point in time t0 the heating device 3 is left in the regular operation mode or is further operated in the regular operation mode. In the region on the right in FIG. 2, the temperature profile is shown in the continuous operation mode 40, in which the temperature rises continuously and considerably, by the upper line.

FIG. 1 and FIG. 2 show the same timing, that is to say they show in each case pressure and temperature at the same point in time. The point in time t0 in FIG. 1 thus corresponds to the point in time t0 in FIG. 2.

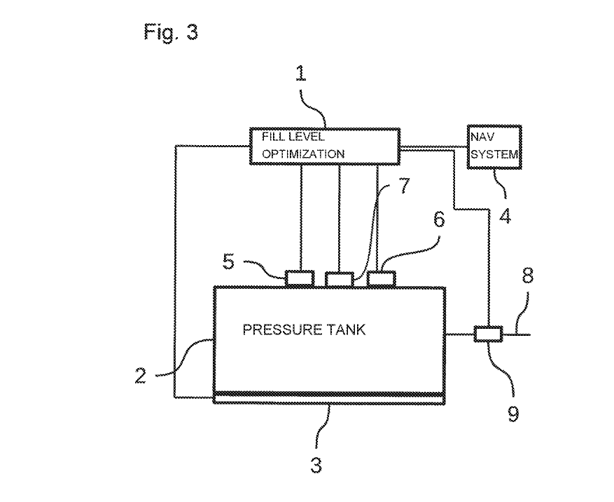

FIG. 3 shows a filling level optimization device 1 with a pressure tank 2. A heating device 3 is arranged for heating the gas in the pressure tank 2 or for heating the pressure tank 2. The heating device 3 is arranged on an outer side or on the pressure tank 2. Alternatively, it is possible for the heating device to be arranged (partially or completely) inside the pressure tank 2. The filling level optimization device 1 detects the pressure of the gas in the pressure tank 2 via a pressure sensor 6. The density of the gas in the pressure tank 2 is detected via a density sensor 7. The filling level optimization device 1 detects the temperature of the gas in the pressure tank 2 via a temperature sensor 5. Gas is extracted from the pressure tank 2 via an extraction line 8 and fed to the fuel cell. A throughflow measurement device 9 measures the quantity of gas which flows through the extraction line 8. This measurement variable too is detected by the filling level optimization device 1. It is also contemplated that the quantity of gas which flows through the extraction line 8 is calculated via the temperature profile and the pressure profile of the gas in the pressure tank 2. The filling level optimization device 1 is connected to a navigation system 4. The route information is received from the navigation system 4. The navigation system 4 can be a conventional navigation system. The navigation system 4 determines or calculates (after specification of a destination) the route to the destination. The filling level optimization device 1 can in particular be a control unit. The control unit can also perform further tasks. It is also contemplated that the navigation system 4 is integrated in the filling level optimization device 1.

The filling level optimization device 1 with the pressure tank 2 is arranged in a motor vehicle, for example a passenger motor vehicle, a truck or a motorcycle.

The temperature profile 40 in the continuous operation mode (upper line in the region on the right in FIG. 2) rises continuously since the heating device 3 heats the gas in the pressure tank 2 continuously. The heating lies in the region of several dozen kelvin. Consequently, the pressure rises above the predefined pressure value. After a certain time, the quantity of gas in the pressure 2 tank becomes low, with the result that the pressure in the pressure tank 2 drops again despite further heating by the heating device 3 in the continuous operation mode.

Without consideration of the route information, the heating device 3 would already be switched from the regular operation mode into the continuous operation mode before the point in time t0, since the detected density was below the predefined density value. Through the consideration of the route information, switching into the continuous operation mode occurs later, so that the gas in the pressure tank 2, or the pressure tank 2 itself, is colder when the next refilling procedure is carried out, with the result that quantity of gas or the gas density in the pressure tank is increased after the (maximum) refilling procedure is carried out.

If the predefined or predetermined density value is undershot, the current consumption of gas and the remaining quantity of gas in the pressure tank 2 is detected. Subsequently (if appropriate in consideration of the current consumption), the residual range of the motor vehicle, which residual range is possible with the available quantity of gas in the pressure tank 2, is determined without switching the heating device 3 from the regular operation mode into the continuous operation mode. Also, (open) refueling stations, in particular gas refueling stations, which are available on the route to the destination or along the route to the destination, are determined. In this case, the selected refueling management mode, that is to say whether a lowest possible number of refueling stops on the route to the destination, a shortest possible travel time to the destination, or a largest possible range after refilling is carried out has the higher priority, is taken into consideration. As long as the quantity of gas in the tank is sufficient to reach (on the route to the destination of the motor vehicle) a refueling station, in particular a gas refueling station without switching the heating device 3 from the regular operation mode into the continuous operation mode, the heating device 3 is (firstly) not switched into the continuous operation mode or operated in the continuous operation mode, but rather the heating device 3 is (further) operated in the regular operation mode. Then one of the reachable refueling stations, in particular gas refueling stations, is selected on this basis, and the driver is informed about the decision or recommendation. In addition, the route to the selected gas refueling station can be displayed to the driver on the navigation system 4.

If the driver does not approach the selected gas refueling station or communicates via an input unit that the approach to the selected gas refueling station is not desired, a new (other) gas refueling station is selected according to the available data concerning the gas in the pressure tank 2, and the route information, and according to the selected refueling management mode, and the driver is informed about the newly selected or recommended gas refueling station. Moreover, it is determined whether the heating device 3 has to be switched from the regular operation mode into the continuous operation mode in order to reach a (another) gas refueling station.

If it is determined that no gas refueling station is able to be reached (any more) on the route to the destination with the available gas in the pressure tank 2 without the heating device 3 being switched into the continuous operation mode, the heating device 3 is switched into the continuous operation mode and operated in the continuous operation mode in order to avoid a breakdown of the motor vehicle due to lack of fuel.

The density value of the gas in the pressure tank 2 can be detected in various ways: By measuring the weight of the gas in the pressure tank 2 in consideration of the volume of the pressure tank 2, it is possible for the density of the gas in the pressure tank 2 to be determined. Alternatively, the density of the gas in the pressure tank 2 can be determined via a throughflow measurement device 9, which measures the quantity of gas which flows out of the pressure tank 2 or is extracted from the pressure tank 2 and is passed to the fuel cell, at a known initial density of the gas in the pressure tank 2 and at a known volume of the pressure tank 2. Other methods for detecting the density of the gas inside the pressure tank 2, for example by way of a gas density measurement device or a density sensor 7, are possible.

### LIST OF REFERENCE SIGNS

1 Filling level optimization device
2 Pressure tank
3 Heating device
4 Navigation system
5 Temperature sensor
6 Pressure sensor
7 Density sensor
8 Extraction line
9 Throughflow measurement device
10 Pressure profile in the regular operation mode
20 Pressure profile in the continuous operation mode
30 Temperature profile in the regular operation mode
40 Temperature profile in the continuous operation mode

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for optimizing a filling level, which is able to be reached during a refilling procedure, of a cryogenic pressure tank for a motor vehicle, wherein a heating device for heating a gas in the pressure tank has at least two modes:
a regular operation mode, in which the heating device heats the gas in the pressure tank such that a predefined pressure of the gas in the pressure tank is reached, and
a continuous operation mode, in which the heating device heats the gas in the pressure tank continuously such that the pressure of the gas in the pressure tank rises beyond the predefined pressure,
wherein the method comprises the steps of:
detecting a density of the gas in the pressure tank;
comparing the detected density of the gas in the pressure tank with a predefined density value; and,
if during the comparison it is determined that the detected density drops below the predefined density value, then, depending on at least one item of route information of the motor vehicle and/or on a target range of the motor vehicle, either
(a) operating the heating device in the regular operation mode,
or
(b) switching the heating device from the regular operation mode into the continuous operation mode.

2. The method as claimed in claim 1, wherein
the at least one item of route information of the motor vehicle is a determined route to a destination of the motor vehicle and refueling stations provided on the determined route to the destination for refilling the pressure tank with gas.

3. The method as claimed in claim 1, wherein
the decision as to whether the heating device is operated in the regular operation mode, or whether the heating device is switched from the regular operation mode into the continuous operation mode, is additionally dependent on a selected refueling management mode which is selectable from multiple different refueling management modes, wherein
the different refueling management modes weight differently multiple goals.

4. The method as claimed in claim 3, wherein the multiple goals weighted differently comprise:
a short travel time of the motor vehicle to the destination, a low number of required refueling procedures for refilling the pressure tank until reaching the destination, and a maximum range of the motor vehicle with the gas in the pressure tank after a refilling procedure of the pressure tank is carried out.

5. The method as claimed in claim 3, wherein
a refueling station for refilling the pressure tank is furthermore selected, depending on a current gas consumption, a detected density of the gas in the pressure tank, the at least one item of route information and/or the target range of the motor vehicle and/or the selected refueling management mode, from the refueling stations which are able to be reached with the available gas in the pressure tank, and a driver is informed about the selected refueling station.

6. The method as claimed in claim 3, further comprising the step of:
displaying the route to the selected refueling station via a navigation system.

7. The method as claimed in claim 1, wherein
a maximum possible refilling quantity of the pressure tank with gas and/or a maximum possible driving distance of the motor vehicle after the pressure tank has been completely refilled with gas is calculated in dependence on the temperature of the gas in the pressure tank and depending on the density of the gas in the pressure tank, and
the decision as to whether the heating device is operated in the regular operation mode, or whether the heating device is switched from the regular operation mode into the continuous operation mode, is additionally dependent on the result of said calculation.

8. The method as claimed in claim 2, wherein
if during the comparison it is determined that the detected density is below the predefined density value, the heating device is operated in the regular operation mode in case of a positive determination that, on the determined route to the destination, a refueling station is able to be reached with the available gas in the pressure tank without switching the heating device into the continuous operation mode.

9. The method as claimed in claim 5, wherein
if it is detected that the selected refueling station is not being approached by the motor vehicle, a new decision is made as to whether the heating device is operated in the regular operation mode, or whether the heating device is switched from the regular operation mode into the continuous operation mode.

10. The method as claimed in claim 5, wherein
if it is detected that the selected refueling station is not being approached by the motor vehicle,
a refueling station for refilling the pressure tank is again selected, depending on the current gas consumption, the detected density of the gas in the pressure tank, the at least one item of route information and/or the target range of the motor vehicle and/or the refueling management mode, from the refueling stations which are able to be reached with the available gas in the pressure tank, and the driver is informed about the newly selected refueling station.

11. A filling level optimization device for optimizing a filling level, which is able to be reached during a refilling procedure, of a cryogenic pressure tank in a motor vehicle, comprising:
a heating device for heating a gas in the pressure tank, the heating device having at least two modes: (1) a regular operation mode, in which the heating device heats the gas in the pressure tank such that a predefined pressure is reached, and (2) a continuous operation mode, in which the heating device heats the gas in the pressure tank continuously such that the pressure of the gas in the pressure tank rises beyond the predefined pressure, wherein
the filling level optimization device is configured such that, if a detected density of the gas in the pressure tank is below a predefined density value, the filling level optimization device switches the heating device from the regular operation mode into the continuous operation mode depending on the at least one item of route information and/or on a target range of the motor vehicle.

12. A pressure tank with a filling level optimization device as claimed in claim 11.
